(19) United States
(12) Patent Application Publication
(10) Pub. No.: US 2021/0214979 A1
(43) Pub. Date: Jul. 15, 2021

(54) OBJECT TRANSFER DEVICE

(71) Applicant: HI-LEX CORPORATION, Hyogo (JP)

(72) Inventor: Nobuyoshi MURATA, Hyogo (JP)

(21) Appl. No.: 17/059,569

(22) PCT Filed: May 30, 2019
(86) PCT No.: PCT/JP2019/021521

§ 371 Date: Nov. 30, 2020

(30) Foreign Application Priority Data
May 31, 2018 (JP) 2018-104945

(51) Int. Cl. E05D 15/16

(52) U.S. Cl. CPC E05D 15/165; B60J 1/17

(57) ABSTRACT

Provided is an object moving device that includes: a base member that includes a guide portion; a carrier member that moves an object; and a sliding member that slides the guide portion. The sliding member is connected to the carrier member. The carrier member is provided with a recessed portion in a carrier member-side connecting portion connected to the sliding member, the recessed portion including a direction indication portion. A lubricant that reduces a force of friction between the carrier member and the sliding member is applied to the carrier member-side connecting portion. Thus, the object moving device that makes it easy to set and adjust the angle of the carrier member and to retain the lubricant is provided.

### TECHNICAL FIELD

The present invention relates to an object moving device.

### BACKGROUND ART

As an object moving device that moves a window glass as an object, there is a window regulator in which the window glass that is the object is attached to a carrier member, and the carrier member (for example, a carrier plate) moves so as to cause a change in angle with respect to a door panel when the window glass moves. As such a device, for example, there is a window regulator in which a shaft of a roller is fixed to a carrier plate, and the roller rolls with respect to a guide rail, and thus, the carrier plate moves (e.g., Patent Literature (hereinafter, referred to as PTL) 1).

### CITATION LIST

### Patent Literature

PTL 1

Japanese Patent Application Laid-Open No. 2002-188358

### SUMMARY OF INVENTION

### Technical Problem

Since the aforementioned object moving device requires the roller, a thickness for an shaft of a roller to extend from the carrier member is needed, and the number of components is also increased. When no roller is used in the object moving device, a lubricant for smoothing sliding of the carrier plate is required in the object moving device.

For this reason, the object moving device is required to cause the lubricant applied to the carrier plate to be retained.

Further, in an object moving device in which a carrier plate moves, while the angle of the carrier plate with respect to a door panel changes, as in the window regulator of PTL 1, it is also necessary to set and adjust the angle of the carrier plate with respect to the door panel, for example, by attaching the door panel with the carrier plate being in a horizontal state.

An object of the present invention is to provide an object moving device that makes it easy to set and adjust the angle of a carrier member (carrier plate) and to retain a lubricant.

### Solution to Problem

The object moving device of the present invention includes:

a base member that includes a guide portion;

a carrier member that moves an object; and

a sliding member that slides the guide portion, wherein

the sliding member is connected to the carrier member,

the carrier member is provided with a recessed portion in a carrier member-side connecting portion connected to the sliding member, the recessed portion including a direction indication portion, and

a lubricant that reduces a force of friction between the carrier member and the sliding member is applied to the carrier member-side connecting portion.

### Advantageous Effects of Invention

According to the present invention, it is possible to realize an object moving device that makes it easy to set and adjust the angle of a carrier member (carrier plate) and to retain a lubricant.

### BRIEF DESCRIPTION OF DRAWINGS

FIG. 1 is a front view of an overall configuration of an object moving device according to an embodiment of the present invention;

FIG. 2 is a front view of a configuration of a main portion of the object moving device according to the embodiment of the present invention;

FIG. 3 is a front view of a carrier member in the object moving device according to the embodiment of the present invention;

FIG. 4 is a cross-sectional view in an arrow direction taken along line A-A of FIG. 2;

FIG. 5 is a diagram illustrating a carrier member-side connecting portion of the carrier member;

FIG. 6A to FIG. 6C are diagrams provided for describing a first sliding member;

FIG. 7A and FIG. 7B are diagrams provided for describing a second sliding member; and

FIG. 8 is a side cross-sectional view of a stabilizer.

### DESCRIPTION OF EMBODIMENT

Hereinafter, an embodiment of the present invention will be described in detail with reference to the accompanying drawings.

<Overall Configuration of Object Moving Device>

An object moving device is a device for moving a carrier member by transmitting a driving force, via a sliding member that slides a guide portion of a base member, to the carrier member connected to the sliding member. The object that the object moving device moves may be an object that is a separate body from the object moving device and is connected to the carrier member, or may be the carrier member itself.

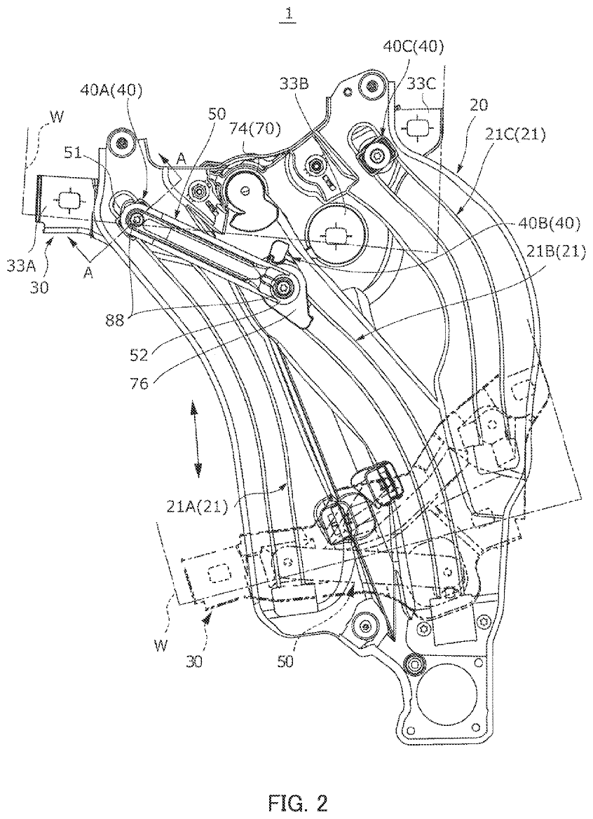

The object moving device of the present embodiment may be used in any device as long as the device moves a carrier member, and can be used in a window glass raising and lowering device or other devices. The other devices to which the object moving device may be applied include, for example, a device that raises and lowers a window glass, a metal plate or a plate made of a resin. As other opaque plates such as a plate made of a resin, it may use a plate capable of displaying a captured image or the like, such as of a surrounding scenery similar to a surrounding scenery visible through a glass. In particular, when object moving device 1 moves an object such as a window glass, a metal plate and a plate made of a resin, object moving device 1 moves carrier member 30 while changing the attitude of carrier member 30 (see FIG. 2).

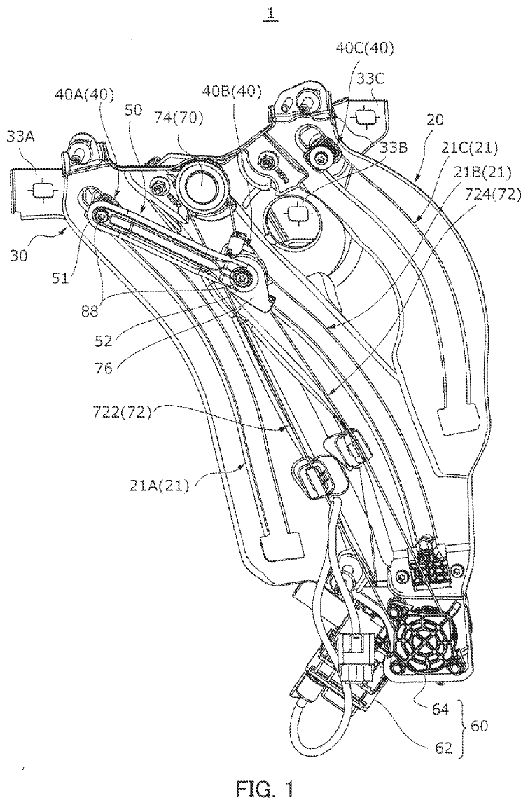

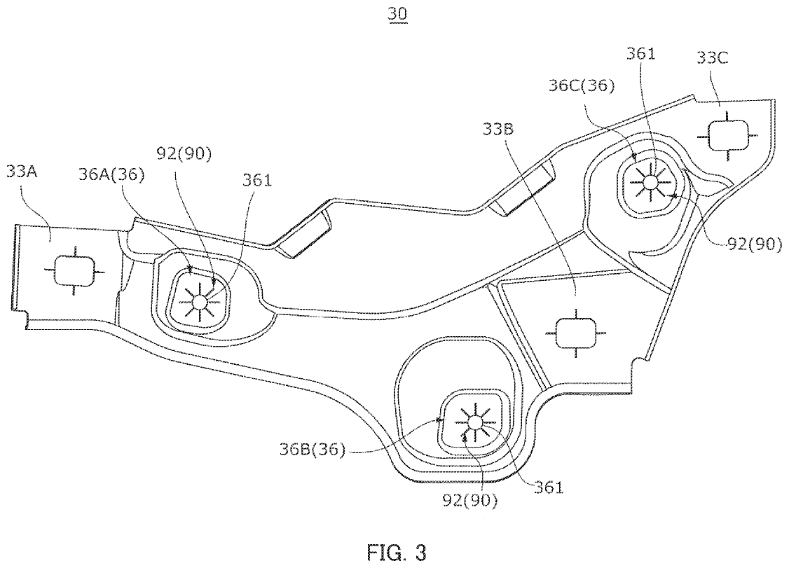

For example, object moving device 1 of the present embodiment illustrated in FIG. 1 to FIG. 3 is fixed between an inner panel and an outer panel of a door of a vehicle and in a part above a tire house of a rear wheel, and is applied to a window regulator for a sashless type quarter window, or the like. In the present embodiment, the moving direction of carrier member 30 (for example, a carrier plate) is an up-down direction defined by using as a reference a raising and lowering direction of the quarter window, which is the object. In object moving device 1, as illustrated in FIG. 2, when carrier member 30 is moved, carrier member 30 moves while rotating, and carrier member 30 at a position above (the position of carrier member 30 indicated by a solid line) and carrier member 30 that is positioned below by the movement (indicated by a broken line) are disposed in different attitudes.

As illustrated in FIG. 1 to FIG. 4, object moving device 1 includes base member 20, carrier member 30, and sliding member 40 (40A to 40C) as well as stabilizer 50, drive section 60, and driving force transmission section 70.

### [Drive Section 60]

Drive section 60 moves carrier member 30 upward and downward via driving force transmission section 70.

Specifically, drive section 60 moves carrier member 30 by winding and unwinding cable 72 of driving force transmission section 70.

Drive section 60 is connected to one end of cable 72, specifically, one end of raising cable 722 and one end of lowering cable 724, respectively.

In the present embodiment, drive section 60 includes motor 62 that is electrically driven, drum 64, and a power transmission section (not illustrated) that transmits rotational motion of motor 62 to drum 64, such as a worm gear, for example. Drive section 60 rotationally drives motor 62 in a forward direction and in a backward direction, and drum 64 rotates in the forward direction and in the backward direction by the rotational driving.

In the present embodiment, drive section 60 is disposed at another end of base member 20.

In the rotational driving of motor 62, drum 64 rotates in the forward direction and in the backward direction. The one ends (in this case, the respective one ends) of raising cable 722 and lowering cable 724 are connected to drum 64 in which raising cable 722 and lowering cable 724 are wound in opposite directions to each other.

Drum 64 winds raising cable 722 by the rotation in the forward direction or in the backward direction to pull raising cable 722, or winds lowering cable 724 thereby to pull lowering cable 724. Drum 64 unwinds lowering cable 724 when drum 64 winds raising cable 722, and unwinds raising cable 722 when drum 64 winds lowering cable 724. In the present embodiment, drive section 60 is provided at the other end of base member 20, but may be provided at one end of base member 20, may be provided between the one end and the other end of base member 20, or further may be provided away from base member 20.

### [Driving Force Transmission Section 70]

Driving force transmission section 70 transmits a driving force generated by drive section 60 to carrier member 30. Driving force transmission section 70 includes cable 72 and direction-changing member 74. Cable 72 is a member that moves carrier member 30 in the up-down direction of the drawing in FIG. 2, and transmits the driving force generated by drive section 60 to carrier member 30.

Cable 72 is a long member that connects drive section 60 with carrier member 30, and is moved by the driving force of drive section 60.

Specifically, cable 72 moves carrier member 30 in the up-down direction by converting the driving force of drive section 60 into a tensile force to pull carrier member 30.

For example, a wire formed by twisting a plurality of at least one of metal element wires and resin fiber element wires can be used as cable 72.

Cable 72 has flexibility enabling the direction of cable 72 to be changed by direction-changing member 74, for example.

Cable 72 is linearly disposed, in a state in which tension is applied thereto, in a region between drive section 60 and direction-changing member 74, in a region between direction-changing member 74 and tension retaining portion 76 connected to carrier member 30, and in a region between tension retaining portion 76 and drive section 60, for example.

By the movement of cable 72 in the up-down direction, cable 72 causes carrier member 30 to move in the up-down direction in conjunction with the driving of drive section 60.

Specifically, cable 72 includes raising cable 722 and lowering cable 724. Lowering cable 724 pulls carrier member 30 downward. Lowering cable 724 is connected to carrier member 30 at another end of lowering cable 724, and is connected to drum 64 of drive section 60 at the one end thereof. Raising cable 722, on the other hand, pulls carrier member 30 upward. Raising cable 722 is connected to drum 64 of drive section 60 at the one end of cable 722, is wound around direction-changing member 74 at another end thereof, and is connected to tension retaining portion 76 connected to carrier member 30. Note that, the other end of raising cable 722 and the other end of lowering cable 724 are connected to tension retaining portion 76, and tension retaining portion 76 retains raising cable 722 and lowering cable 724 in a state in which tension is applied to both raising cable 722 and lowering cable 724. For example, tension retaining portion 76 is connected to the respective other ends of raising cable 722 and lowering cable 724 in a state of being energized by a spring so as to pull the respective other ends. In object moving device 1, in a case where elongation occurs in raising cable 722 and lowering cable 724, tension retaining portion 76 displaces each position of the other ends of raising cable 722 and lowering cable 724 to which tension retaining portion 76 is connected, in the extending direction by the energizing force of the spring to absorb the elongation, and always retains raising cable 722 and lowering cable 724 in a state in which appropriate tension is applied thereto.

Direction-changing member 74 change the moving direction of cable 72 on base member 20. As direction-changing member 74, a resin-made guide having elasticity to guide cable 72 along the changing direction, a pulley or the like is used, for example. Direction-changing member 74 is disposed apart in the moving direction of carrier member 30. In the present embodiment, direction-changing member 74 is disposed on a side of another end of the moving direction of carrier member 30, whereas drive section 60 is disposed on a side of one end of the moving direction of carrier member 30.

In the present embodiment, raising cable 722 extending from drum 64 toward the side of the other end (the upper end) is wound around direction-changing member 74, and direction-changing member 74 changes the moving direction of raising cable 722.

Direction changing member 74 changes motion of pulling down a side of the one end of raising cable 722 connected to drum 64 downward to motion of pulling up the other end of raising cable 722 connected to tension retaining portion 76 of carrier member 30 upward.

### [Base Member 20]

Base member 20 guides the movement of carrier member 30, and movably supports carrier member 30.

Base member 20 supports carrier member 30 such that carrier member 30 is capable of being raised and lowered along the extending direction of base member 20 (the direction in which base member 20 extends).

Specifically, base member 20 includes guide portions 21A to 21C that guide the movement of carrier member 30.

Guide portions 21A to 21C are provided as guide grooves extending along the moving direction of carrier member 30. The guide groove movably guides sliding member 40 (40A to 40C) along the extending direction of the guide groove. In guide portions 21A to 21C, the guide grooves are elongated hole-shaped opening portions provided in base member 20. In the present embodiment, rotation regulation portion 24 such as a rib, which restrains sliding member 40 (40A to 40C) that slides the rail from rotating in an axial direction of base member 20, is provided in an edge portion extending along the longitudinal direction of the guide groove, that is, the extending direction of base member 20.

The respective guide grooves of guide portions 21A to 21C are curved in a width direction, and are disposed in parallel with each other in an oblique direction. The width direction mentioned here is a direction perpendicular to the extending direction of base member 20, more specifically, the left-right direction of object moving device 1 corresponding to the width direction of the object to be moved (hereinafter, referred to as “movement object”). Guide portions 21A to 21C can also be configured, without being limited to those in the present embodiment, as end portions extending in a longitudinal direction of a rail-shaped member.

In the present embodiment, base member 20 is formed of a resin material, and the weight of base member 20 is reduced compared to a conventional guide rail made of metal.

Base member 20 is formed in a curved shape as a whole such that at least a side of the one end of base member 20 protrudes on a side of one surface, in this case, a surface on which carrier member 30 is disposed (which is referred to as “rear surface” for convenience in the present embodiment).

In the present embodiment, drum 64, direction-changing member 74, and cable 72 are disposed on a front side of base member 20.

Note that, in the present embodiment, all of the extending direction of base member 20 and the moving directions of raising cable 722 and lowering cable 724 are an up-down direction in accordance with the movement of carrier member 30 in the up-down direction, but are not limited thereto. When the moving direction of carrier member 30 is a direction different from the up-down direction, the extending direction of base member 20 and the moving directions of raising cable 722 and lowering cable 724 may be any directions such as left-right directions, for example. These moving directions can be appropriately set depending on the moving direction of the movement object.

### [Carrier Member 30]

Although the movement object is connected to carrier member 30, carrier member 30 itself may be the movement object.

Carrier member 30 is moved by drive section 60 via cable 72. In a case where the movement object is connected to carrier member 30, carrier member 30 moves the movement object.

In the present embodiment, carrier member 30 moves upward and downward by being guided by base member 20. Specifically, carrier member 30 is connected to sliding member 40 (40A to 40C) which are fitted to guide portions 21A to 21C extending between the side of the one end and the side of the other end of base member 20, and which are freely movable along guide portions 21A to 21C. Carrier member 30 is movable upward and downward by being guided by guide portions 21A to 21C.

In the present embodiment, carrier member 30 retains a lower end portion of window glass W, and is guided along base member 20 (specifically, guide portions 21A to 21C that are the guide grooves of base member 20) in the up-down direction of window glass W. Respective parts of carrier member 30 connected to guide portions 21A to 21C are guided by guide portions 21A to 21C, and thus, carrier member 30 as a whole is raised and lowered, and moves while rotating or the like in the process of raising and lowering.

Carrier member 30 moves between the side of the one end (the side of the upper end in FIG. 1) and the side of the other end (the side of the lower end in FIG. 1) of base member 20, and moves window glass W, which is the movement object.

In the present embodiment, carrier member 30 is formed on a rear side of base member 20 by a board body extending in a direction (the width direction of object moving device 1) intersecting the moving direction of carrier member 30.

Carrier member 30 includes object fixing portions 33A to 33C that fix window glass W (in detail, the lower end portion of window glass W), which is the object, and carrier member-side connecting portions 36A to 36C connected to sliding member 40 (40A to 40C).

Object fixing portions 33A to 33C are parts that fix the movement object (window glass W in the present embodiment). In the present embodiment, window glass W is disposed on the rear side of base member 20 by object fixing portions 33A to 33C.

### [Carrier Member-Side Connecting Portion 36 (36A to 36C)]

Carrier member-side connecting portions 36A to 36C are parts connected to sliding member 40 (40A to 40C) such that carrier member 30 moves along base member 20 on the rear side of base member 20. In the present embodiment, carrier member-side connecting portions 36A to 36C are provided at three positions in carrier member 30, but may be provided at two positions or at four or more positions.

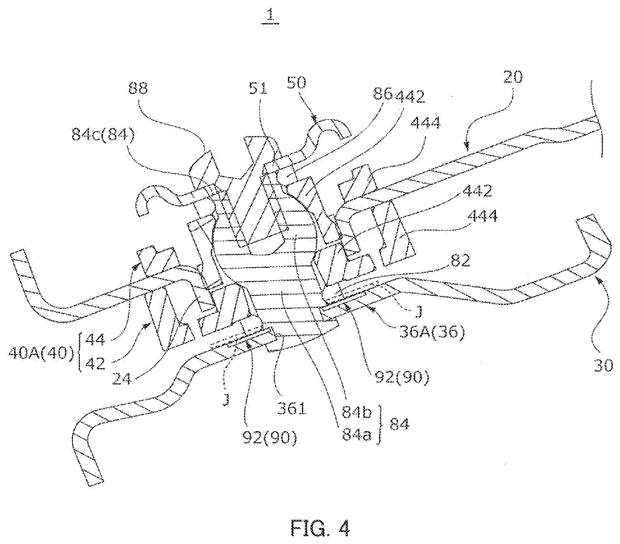

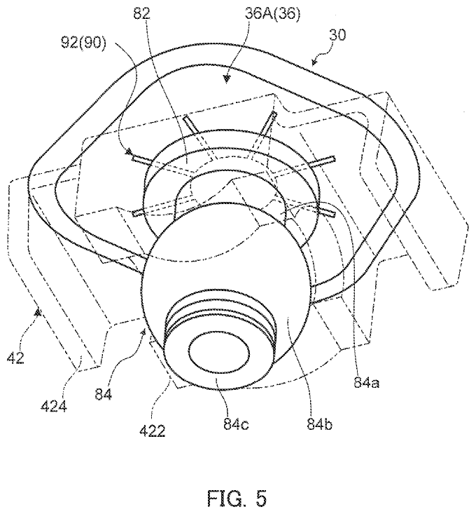

Note that, since carrier member-side connecting portions 36A to 36C are configured in the same manner, carrier member-side connecting portion 36A will be described with reference to FIG. 4 and FIG. 5, and a description of carrier member-side connecting portions 36B and 36C will be omitted.

In the present embodiment, carrier member-side connecting portions 36A to 36C are attached to sliding member 40 via connecting member 84 as illustrated in FIG. 4 and FIG. 5. Note that, FIG. 5 is a diagram illustrating carrier member-side connecting portion 36A of carrier member 30, specifically, is a diagram illustrating a front side of carrier member-side connecting portion 36A in object moving device 1. Carrier member-side connecting portions 36A to 36C are each provided with recessed portion 90 including direction indication portion 92, and are formed in the same manner, respectively. Hereinafter, the configuration of carrier member-side connecting portion 36A, and the connection structure between carrier member-side connecting portion 36A and base member 20 will be described with reference to FIG. 4 and FIG. 5, and detailed descriptions of the configurations of carrier member-side connecting portions 36B and 36C, and the connection structure between carrier member-side connecting portion 36B or 36C and base member 20 will be omitted.

In each of carrier member-side connecting portions 36A to 36C, recessed portion 90 is provided to open to a side of sliding member 40 in a direction of a connection axis of sliding member 40 with carrier member 30. The connection axis mentioned here is a direction in which sliding member 40 is connected to carrier member 30, and is a direction penetrating, in base member 20, a surface on a side on which carrier member 20 is disposed, and a surface on which cable 72 or the like is routed. In the present embodiment, the connection axis means the thickness direction of base member 20, and a direction that crosses a surface including the extending directions of guide portions 21A to 21C in guide portions 21A to 21C, respectively.

Recessed portion 90 is preferably a long groove. Recessed portion 90 is configured such that lubricant J enters into the interior of recessed portion 90.

Recessed portion 90 is provided in a range in which direction indication portion 92 is visually recognizable in a case of viewing carrier member 30 from above of sliding member 40 in the direction of the connection axis of sliding member 40 with carrier member 30.

[Direction indication portion 92]

Direction indication portion 92 indicates a direction in carrier member 30, and indicates the attitude of carrier member 30 in the present embodiment. Direction indication portion 92 may be formed to make it possible to determine how much carrier member 30 is inclined with respect to a predetermined direction such as a vertical direction and a horizontal direction. By determining the inclination of carrier member 30 with respect to a predetermined direction, it is possible to easily grasp whether carrier member 30 is correctly attached to base member 20 or the like.

In the extending direction of direction indication portion 92, for example, direction indication portion 92 indicates two directions orthogonal to each other on carrier member-side connecting portions 36A to 36C.

In the present embodiment, direction indication portion 92 has a shape of a plurality of line segments provided radially around a connection axis of sliding member 40 with carrier member 30, that is, around through-hole 361.

Recessed portion 90 in its entirety configures direction indication portion 92.

In the present embodiment, direction indication portion 92 is formed by processing carrier member-side connecting portion 36A into a recessed shape by punching, but recessed portion 90 may suffice as long as lubricant J enters into recessed portion 90 and is stored therein. For example, recessed portion 90 may be formed with protrusions that are apart from each other and face each other, and direction indication portion 92 may be formed with recessed portion 90 mentioned above. The width of recessed portion 90 is not particularly limited as long as recessed portion 90 is capable of retaining lubricant J such as grease, and recessed portion 90 may be a recessed portion formed between protrusion portions.

Direction indication portion 92 is formed around through-hole 361 with recessed portion 90 that is linear and extends along each direction of the horizontal direction and the vertical direction.

As illustrated in FIG. 5, direction indication portion 92 is provided radially from through-hole 361, and is linearly provided to extend to the outside in a radial direction of buffer material 82 that is externally fitted to connecting member 84 provided in through-hole 361.

Note that, direction indication portion 92 may be formed by linearly disposing recessed dots or short grooves, which are formed in carrier member-side connecting portion 36A, to extend radially from through-hole 361.

Further, direction indication portion 92 may be formed in any way as long as direction indication portion 92 is formed in a recessed shape with recessed portion 90 and indicates a direction. Direction indication portion 92 may have any indication form as long as the indication form is formed with recessed portion 90 in which a direction is visually recognizable by a direction-indicating arrow, letter, symbol or the like. Direction indication portion 92 may have unevenness that does not hinder a smooth movement of carrier member 30, and may be capable of retaining lubricant J.

In the central portion of carrier member-side connecting portion 36A, connecting member 84 protrudes on a front side of carrier member 30.

Connecting member 84 freely rotatably connects carrier member-side connecting portion 36A, that is, carrier member 30 with sliding member 40.

Specifically, carrier member-side connecting portion 36A is a flat board-shaped part which through-hole 361 is formed at a center. Connecting member 84 is a rod-shaped body, a side of a base end portion of connecting member 84 is inserted into through-hole 361 of carrier member-side connecting portion 36A and is fixed therein, and a side of a leading-end portion of connecting member 84 protrudes on the front side of carrier member 30.

Connecting member 84 is provided with shaft portion 84a whose base end portion is fixed to carrier member-side connecting portion 36A, and rotation connection portion 84b provided at a leading-end of shaft portion 84a, freely rotatably engages with sliding member 40 and is connected thereto.

Rotation connection portion 84b engages with sliding member 40 in guide portions 21A to 21C, and is connected to sliding member 40 such that rotation connection portion 84b does not come off from sliding member 40. Rotation connection portion 84b is, for example, a ball joint portion, is formed in a spherical shape, and a fixing hole to which fastening member 88 is inserted and is fastened is provided at leading-end portion 84c of rotation connection portion 84b.

Around shaft portion 84a of connecting member 84, buffer material 82 having an O-shape is disposed.

Buffer material 82 is an O-ring, and is interposed between carrier member-side connecting portion 36A and sliding member 40 to prevent both from coming in contact with each other. Further, lubricant J such as grease is interposed between carrier member-side connecting portion 36A and buffer member 82 as a matter of course, and between buffer member 82 and sliding member 40.

Lubricant J reduces a force of friction between carrier member 30 and sliding member 40. Note that, although object moving device 1 of the present embodiment is configured to include buffer material 82 between carrier member 30 and sliding member 40, buffer material 82 may be dispensed with. Even lubricant J alone may be capable of realizing smooth movements of both carrier member 30 and sliding member 40 by reducing the force of friction when carrier member 30 and sliding member 40 come in contact with each other.

### [Sliding Member 40]

Sliding member 40 (40A to 40C) is connected to carrier member 30 via carrier member-side connecting portion 36, and is freely slidably attached to guide portions 21A to 21C of base member 20.

Sliding member 40 (40A to 40C) attaches carrier member 30 to base member 20 to be movable along the extending directions of guide portions 21A to 21C.

Since sliding members 40A to 40C are configured in the same manner in the present embodiment, sliding member 40A will be described, and descriptions of sliding members 40B and 40C will be omitted.

As illustrated in FIG. 4, sliding member 40A includes first sliding member 42 and second sliding member 44 provided so as to sandwich a rib that is rotation regulation portion 24 of guide portion 21A of base member 20 in the thickness direction of base member 20.

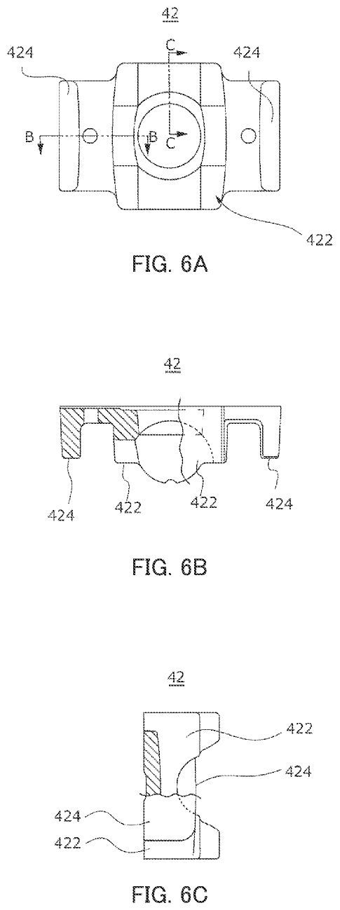

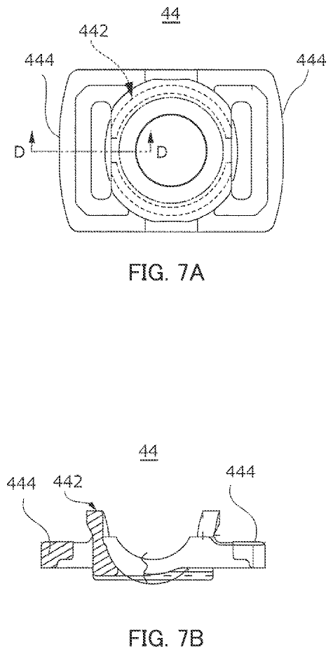

FIG. 6 is a diagram provided for describing first sliding member 42. FIG. 6A is a front view of first sliding member 42, FIG. 6B is a top view of first sliding member 42, including a partial cross-sectional view taken along line B-B, and FIG. 6C is a side view of first sliding member 42, including a partial cross section taken along line C-C. Further, FIG. 7 is a diagram provided for describing second sliding member 44. FIG. 7A is a rear view of second sliding member 44, and FIG. 7B is a top view of second sliding member 44, including a partial cross section taken along line D-D.

Sliding member 40 is formed by fitting first sliding member 42 disposed on a rear side of guide portion 21A of base member 20, and second sliding member 44 disposed on a front side of guide portion 21A of base member 20 such that first sliding member 42 and second sliding member 44 sandwich guide portion 21A.

First sliding member 42 includes rear-side insertion portion 422 that is inserted into guide portion 21A from the rear side to engage with rotation connection portion 84b on a side of shaft portion 84a, and rear-side sliding piece portion 424 that slides the rear surface of base member 20.

Rear-side insertion portion 422 is a recessed body including both side surfaces along the extending direction inside the rib that is rotation regulation portion 24 of guide portion 21A, opens in a hemispherical shape, and freely slidably houses therein a hemispherical portion of rotation connection portion 84b having a spherical shape. A through-hole continuous with the inside of the recessed body is formed at a center of a bottom surface of the recessed body. Rear-side insertion portion 422, in a state in which shaft portion 84a is inserted into the through-hole, slidably houses rotation connection portion 84b inside the recessed portion. Rear-side insertion portion 422 receives rotation connection portion 84b on the rear side to be freely movable around rotation connection portion 84b around the connection axis.

Rear-side sliding piece portion 424 faces rear-side insertion portion 422 in the width direction of guide portion 21A. Rear-side sliding piece portion 424 and rear-side insertion portion 422 are disposed such that rear-side sliding piece portion 424 and rear-side insertion portion 422 sandwich the rib that is rotation regulation portion 24 of guide portion 21A.

Second sliding member 44 includes front-side insertion portion 442 that is inserted into guide portion 21A from the front side to engage with rotation connection portion 84b, and front-side sliding piece portion 444 that slides the front surface of base member 20.

Front-side insertion portion 442 is disposed inside the rib that is rotation regulation portion 24 of guide portion 21A. Front-side insertion portion 442 is a cylindrical body whose rear side opens in a hemispherical shape, and whose front side opens with an opening having a smaller diameter than the opening on the rear side, and houses rotation connection portion 84b such that a leading-end of rotation connection portion 84b is exposed on the front side. Front-side insertion portion 442 receives rotation connection portion 84b on the front side to be freely movable around rotation connection portion 84b around the connection axis. Thus, in the present embodiment, front-side insertion portion 442 and rear-side insertion portion 422 are disposed such that front-side insertion portion 442 and rear-side insertion portion 422 surround rotation connection portion 84b, and house rotation connection portion 84b to be rotatable around the connection axis.

Front-side sliding piece portion 444 and rear-side sliding piece portion 424 are disposed such that front-side sliding piece portion 444 and rear-side sliding piece portion 424 sandwich base member 20 in the thickness direction, and regulate that base member 20 does not come off in the thickness direction of sliding member 40.

Leading-end portion 84c of rotation connection portion 84b is exposed via the opening on the front side of front-side insertion portion 442, and fastening member 88 that inserts stabilizer 50 and buffer material 86 is fitted to the fixing hole of leading-end portion 84b by insertion. Thus, stabilizer 50 is connected to connecting member 84 via buffer material 86. Note that, buffer material 86 interposed between stabilizer 50 and connecting member 84 may be dispensed with.

Thus, first sliding member 42 and second sliding member 44 are disposed so as to sandwich rotation connection portion 84b positioned inside the opening of guide portion 21A, and rotation regulation portion 24 of guide portion 21A in the thickness direction of base member 20. Rotation connection portion 84b is fixed to carrier member-side connecting portion 36A via shaft portion 84a, and fastening member 88 is fastened to rotation connection portion 84b such that rotation connection portion 84b does not come off from second sliding member 44.

Thus, movement of first sliding member 42 in the thickness direction of guide portion 21A, that is, in the direction of the connection axis and in the width direction of guide portion 21A is regulated by carrier member-side connecting portion 36A, with buffer member 82 being sandwiched between first sliding member 42 and carrier member-side connecting portion 36A, second sliding member 44 (front-side insertion portion 442 and front-side sliding piece portion 444), and rotation regulation portion 24.

Further, movement of second sliding member 44 in the thickness direction of guide portion 21A, that is, in the direction of the connection axis and in the width direction of guide portion 21A is regulated by first sliding member 42 (rear-side insertion portion 422 and rear-side sliding piece portion 424), rotation regulation portion 24, and fastening member 88.

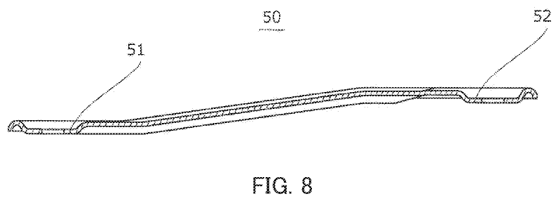

FIG. 8 is a side cross-sectional view of stabilizer 50.

Stabilizer 50 is provided in a hanging manner between carrier member-side connecting portions 36A and 36B that move via sliding member 40 guided by guide portions 21A and 21B of base member 20, and moves carrier member 30 smoothly and in a stable state.

Specifically, in an attitude of carrier member 30 when carrier member 30 moves to base member 20, stabilizer 50 causes a side of carrier member-side connecting portion 36A to be positioned closer to the side of the one end (the side of the upper end in the present embodiment) than carrier member-side connecting portion 36B.

In the present embodiment, stabilizer 50 is made of a long board material, and both of end portions 51 and 52 of stabilizer 50 are respectively freely rotatably fixed to rotation connection portion 84b (see FIG. 4 and FIG. 5) that engages with sliding members 40A and 40B, respectively, via fastening member 88 (see FIG.4) around the connection axis.

Note that, the connection between a side of another end of stabilizer 50 and sliding member 40B is formed by fastening, with fastening member 88, another end portion 52 of stabilizer 50 together with tension retaining portion 76 to rotation connection portion 84b of connecting member 84 that engages with sliding member 40B in the same manner as with sliding member 40A. Further, the connection between carrier member-side connecting portion 36C of carrier member 30 and sliding member 40C has a structure in which stabilizer 50 is not interposed in the connection structure between carrier member-side connecting portion 36A and sliding member 40A, although a detailed description thereof is omitted. Each of carrier member-side connecting portions 36A to 36C is freely rotatably connected to each of sliding members 40A to 40C that slide guide portions 21A to 21C, around the connection axis.

### [Effects of Object Moving Device 1]

According to object moving device 1, base member 20 including guide portions 21A to 21C, carrier member 30 that moves glass window W, which is the object, and sliding members 40A to 40C that slide guide portions 21A to 21C are provided. Sliding members 40A to 40C are connected to carrier member 30. In carrier member 30, recessed portion 90 including direction indication portion 92 is each provided with carrier member-side connecting portions 36A to 36C connected to sliding members 40A to 40C. Further, lubricant J that reduces the force of friction between carrier member 30 and sliding member 40A is applied to carrier member-side connecting portions 36A to 36C (carrier member-side connecting portion 36A in FIG. 4 and FIG. 5).

Lubricant J applied is stored in recessed portion 90 including direction indication portion 92. Further, recessed portion 90 is provided in a range in which direction indication portion 92 is visually recognizable in a case of viewing carrier member 30 from above of sliding member 40A in the direction of the connection axis of sliding member 40A with carrier member 30. Further, in the present embodiment, direction indication portion 92 has a shape of a plurality of line segments provided radially around a connection axis of sliding member 40A with carrier member 30.

Thus, in a case where object moving device 1 is assembled, carrier member 30 is attached to base member 20 via connecting member 84 and sliding member 40. In this case, carrier member 30 can be attached to guide portions 21A to 21C of base member 20 while recognizing the attitude of carrier member 30 by visually recognizing direction indication portions 92 of carrier member-side connecting portions 36A to 36C. That is, it is possible to easily set and adjust the angle of carrier member 30. Further, since lubricant J is stored in direction indication portion 92, in a case where carrier member 30 rotates with respect to sliding member 40A via buffer member 82 when sliding member 40A is guided by guide portion 21A to move, lubricant J adheres to buffer member 82, and to sliding member 40A as well. Then, since lubricant J is supplied by direction indication portion 92 when buffer member 82 rotates with respect to carrier member 30, the movement of carrier member 30 to base member 20 is easily retained in a smooth state. Thus, lubricant J is always interposed between carrier member-side connecting portion 36A and sliding member 40A via buffer member 82, and it is possible to smoothly move, specifically raise and lower, window glass W connected to carrier member 302, by causing carrier member 30 to rotate stably and smoothly. That is, it is possible to easily retain lubricant J by direction indication portion 92.

In the present embodiment, the window regulator is exemplified as an application example of the object moving device, but the object moving device can be also applied to a device such as a walking assisting device as long as the device makes it easy to set and adjust the angle of a carrier member and to retain a lubricant.

The embodiment of the present invention has been described thus far. Note that, the above description is only illustration of a preferred embodiment of the present invention, and the scope of the present invention is not limited thereto. That is, the descriptions of the configuration of the above-mentioned device and the shape of each portion are only exemplary, and it is obvious that various changes and additions to these examples are possible within the scope of the present invention.

### Industrial Applicability

The present invention exhibits an effect of making it easy to set and adjust the angle of a carrier member and to retain a lubricant, and is useful as an object moving device such as a window regulator and a walking assisting device.

### REFERENCE SIGNS LIST

1 Object moving device
20 Base member
21, 21A, 21B, 21C Guide portion
24 Rotation regulation portion
30 Carrier member
33A, 33B, 33C Object fixing portion
36, 36A, 36B, 36C Carrier member-side connecting portion
361 Through-hole
40, 40A, 40B, 40C Sliding member
42 First sliding member
422 Rear-side insertion portion
424 Rear-side sliding piece portion
44 Second sliding member
442 Front-side insertion portion
444 Front-side sliding piece portion
50 Stabilizer
60 Drive section
62 Motor
64 Drum
70 Driving force transmission section
72 Cable
722 Raising cable
724 Lowering cable
74 Direction-changing member
76 Tension retaining portion
82, 86 Buffer material
84 Connecting member
84a Shaft portion
84b Rotation connection portion
84c Leading-end portion
88 Fastening member
90 Recessed portion
92 Direction indication portion

1. An object moving device, comprising:
a base member that includes a guide portion;
a carrier member that moves an object; and
a sliding member that slides the guide portion, wherein
the sliding member is connected to the carrier member,
the carrier member is provided with a recessed portion in a carrier member-side connecting portion connected to the sliding member, the recessed portion including a direction indication portion, and
a lubricant that reduces a force of friction between the carrier member and the sliding member is applied to the carrier member-side connecting portion.

2. The object moving device according to claim 1, wherein
the recessed portion is provided in a range in which the direction indication portion is visually recognizable in a case of viewing the carrier member from above of the sliding member in a direction of a connection axis of the sliding member with the carrier member.

3. The object moving device according to claim 1, wherein
the direction indication portion has a shape of a plurality of line segments provided radially around a connection axis of the sliding member with the carrier member.

4. The object moving device according to claim 2, wherein
the direction indication portion has a shape of a plurality of line segments provided radially around a connection axis of the sliding member with the carrier member.
